(19) United States
(12) Patent Application Publication
(10) Pub. No.: US 2024/0200532 A1
(43) Pub. Date: Jun. 20, 2024

(54) CONTROL SYSTEM FOR WIND ENERGY HARVESTER ARRAYS

(71) Applicant: X Development LLC, Mountain View, CA (US)

(72) Inventor: Ulrich Niemann, Sunnyvale, CA (US)

(21) Appl. No.: 18/068,324

(22) Filed: Dec. 19, 2022

(51) Int. Cl. F03D 5/06; H02N 1/04

(52) U.S. Cl. CPC F03D 5/06; H02N 1/04; F05B 2220/709; F05B 2270/32

(57) ABSTRACT

A power generation system includes: a frame; a plurality of units supported by the frame and configured to convert fluid-induced mechanical energy to electrical energy; a member that is moveable relative to the frame; an actuator operable to move the member; and a controller communicably coupled to the actuator and configured to perform operations comprising: receiving, by the controller, flow data indicating a characteristic of fluid flow over the plurality of units; receiving, by the controller, power data indicating a parameter of electrical power output by the plurality of units; and based on the flow data and the power data, transmitting a control signal to the actuator to cause the actuator to move the member relative to the frame. A first unit of the plurality of units comprises: a first element; and a second element, wherein relative motion between the first element and the second element generates electrical energy.

### TECHNICAL FIELD

This specification relates generally to wind-driven electrical power generators.

### BACKGROUND

Wind is airflow consisting of the many gasses in our atmosphere. Wind obtains its kinetic energy from phenomena such as the rotation of the earth and temperature difference due to unevenly distributed heating in the atmosphere. Many factors, such as undulating terrain, can also influence the intensity distribution of wind. Because of this, wind is considered as a sustainable energy source since it is renewable, widely distributed, and plentiful in nature.

Electricity from wind can be produced by turbines, such as three-bladed horizontal axis wind turbines. Wind turbine systems can include alternators that convert the mechanical energy of the wind turbine to electrical energy. Typically, high wind speed and thus aerodynamic forces are required to overcome the cogging torque of the alternators. Therefore, wind turbines can be large, in some cases reaching hundreds of feet in height.

### SUMMARY

In general, this disclosure relates to a control system for wind energy nanogenerator systems. The control system can be used to dynamically modulate aerodynamic members to manipulate the flow field in order to improve power output.

Nanogenerators are microscopic electromechanical devices that use piezoelectric or triboelectric effects to convert mechanical energy into electricity. Nanogenerators can be used to harvest wind energy in the form of aerodynamic oscillations. Large quantities of nanogenerators can be combined into array panels with the goal of generating moderate electrical power for practical applications.

A power generation system includes a panel including wind energy harvester units. In some examples, the units are arranged in a planar array. The units can be supported by a frame. The units are configured to convert fluid-induced mechanical energy to electrical energy. The system includes a power management circuit configured to receive electrical energy from the plurality of units and to output electrical current.

The system includes a member that is moveable relative to the frame. The member can be, for example, a wing, a half sphere, a cylinder, a plate, or a louver. In some examples, the member extends from a surface of the panel. In some examples, the member is integrated with the surface of the panel.

In some examples, the system includes multiple members. The members can be uniform or can be different from each other. For example, the members can include wings that are all of the same shape and size, wings that are of different shapes and sizes, or a combination of wings and of members having another shape, such as half spheres. The members can be positioned in between adjacent units of the array. The members can be aerodynamic control surfaces.

The member can be moved by an actuator that is communicably coupled to a controller. A closed feedback loop can be used to measure electrical parameters and/or wind flow characteristics and adjust the member to improve the power output by the system. The controller receives flow data indicating a characteristic of fluid flow over the units. In some examples, the flow data includes a bulk wind speed and/or direction across the surface of the panel. The controller receives power data indicating a parameter of electrical power output by the units. In some examples, the controller compares the parameter of the electrical power output by the units to a target parameter.

Based on the flow data and the power data, the controller dynamically manipulates the member by transmitting a control signal to the actuator to cause the actuator to move the member. The actuator is operable to move the member. Movement of the member can affect the speed and/or direction of fluid flow over the units.

The controller can move the member by adjusting the position of the member relative to the frame. For example, the controller can instruct the actuator to increase or decrease an angle between the member and the frame, to raise or lower the member relative to the frame, or to extend or retract the member relative to the frame. In some examples, movement of each member of a plurality of members is controlled individually. In some examples, movement of each member of the plurality of members is controlled uniformly. The controller can continue to move the member or members until the parameter of the electrical power output matches the target parameter within a threshold error.

One innovative aspect of the subject matter described in this specification is embodied in a power generation system including: a frame; a plurality of units supported by the frame and configured to convert fluid-induced mechanical energy to electrical energy; a member that is moveable relative to the frame; an actuator operable to move the member; and a controller communicably coupled to the actuator and configured to perform operations including: receiving, by the controller, flow data indicating a characteristic of fluid flow over the plurality of units; receiving, by the controller, power data indicating a parameter of electrical power output by the plurality of units; and based on the flow data and the power data, transmitting, by the controller, a control signal to the actuator to cause the actuator to move the member relative to the frame.

One innovative aspect of the subject matter described in this specification is embodied in a computer-implemented method including: receiving, by a controller, flow data indicating a characteristic of fluid flow over a plurality of units configured to convert fluid-induced mechanical energy to electrical energy, the plurality of units being supported by a frame; receiving, by the controller, power data indicating a parameter of electrical power output by the plurality of units; and based on the flow data and the power data, transmitting, by the controller and to an actuator that is operable to move a member relative to the frame, a control signal to cause the actuator to move the member.

These and other embodiments can include the following features, alone or in any combination. In some implementations, the power data indicates a measured voltage of electrical energy output by the plurality of units, the operations including: determining, by the controller, a target voltage; and iteratively transmitting, by the controller, control signals to the actuator to cause the actuator to move the member relative to the frame until the measured voltage matches the target voltage within a threshold error.

In some implementations, the power data indicates a measured current of electrical energy output by the plurality of units, the operations including: determining, by the controller, a target current; and iteratively transmitting, by the controller, control signals to the actuator to cause the actuator to move the member relative to the frame until the measured current matches the target current within a threshold error.

In some implementations, the characteristic of fluid flow is a speed of fluid flow, the operations including: determining, by the controller, a target speed of fluid flow over the plurality of units; and iteratively transmitting, by the controller, control signals to the actuator to cause the actuator to move the member relative to the frame until the speed of fluid flow indicated by the flow data matches the target speed of fluid flow within a threshold error.

In some implementations, moving the member includes extending or retracting the member relative to the frame.

In some implementations, moving the member includes increasing or decreasing an angle formed between the member and the frame.

In some implementations, the plurality of units are arranged in a planar array.

In some implementations, the system includes a separator between adjacent units of the plurality of units. The member is mounted to the separator.

In some implementations, the member includes a separator that is located between adjacent units of the plurality of units.

In some implementations, the member is one of a plurality of members, each member of the plurality of members being located between adjacent units of the plurality of units.

In some implementations, the fluid flow includes air flow.

In some implementations, a first unit of the plurality of units includes: a first element; and a second element. Relative motion between the first element and the second element generates electrical energy.

In some implementations, the member includes the first element or the second element.

In some implementations, the first element is planar and the second element is planar and parallel to the first element.

In some implementations, the first element and the second element are configured to remain spaced apart when the first unit is in a resting state and to come into contact with each other when a force is applied to the first unit.

In some implementations, the first element and the second element are enclosed in a housing that is permeable to air; the first element is moveable relative to the housing; and the second element is rigid relative to the housing.

In Some Implementations, Each Unit has a Surface Area of Ten Square Centimeters or Less; and the Plurality of Units Includes at Least One Hundred Units.

In some implementations, each unit of the plurality of units includes a triboelectric nanogenerator.

In some implementations, movement of the member relative to the frame changes the characteristic of fluid flow over the units.

Other embodiments of this and other aspects include corresponding systems, apparatus, and computer programs, configured to perform the actions of the methods, encoded on computer storage devices. A system of one or more computers or other processing devices can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

The methods and systems presented herein provide at least the following technical advantages and/or technical improvements over previously available solutions. The techniques can be used to produce wind-generated electrical power using panels. The panels can be flat or curved. The panels can be freestanding or can be mounted to a structure such as a building. The panels can generate electricity from lower wind speeds, compared to windmills. Wind energy harvesting panels can be installed in locations where windmills cannot be located, such as in cities. Thus, wind energy harvesting panels can be installed in locations where electricity is needed. This can reduce transmission costs to deliver power to loads.

Installing wind energy harvesting panels on a building can reduce the building's reliance on grid power. Installing wind energy harvesting panels on a building can make the building energy self-sufficient. The panels can be made from inexpensive, readily available materials, such as plastics, Teflon, Nylon, and PVC. Wind energy harvesting panels can provide electricity for lighting, air conditioning, and equipment. Wind energy harvesting panels can be used to charge batteries. Wind energy harvesting panels can feed electrical power to an electrical distribution system. Increasing the usage of wind energy could lead to lower dependence on fossil fuels, and gradually decrease global greenhouse gas emission.

Methods in accordance with the present disclosure may include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF THE DRAWINGS

FIG. 1A is a contextual diagram of an example system for generation of electrical power from wind energy harvester arrays.

FIG. 1B shows an example panel including an array of wind energy harvesting units.

FIG. 2A shows the example panel including an array of wind energy harvesting units.

FIG. 2B is a cross-sectional diagram of the example panel of FIG. 2A.

FIG. 3A is a cross-sectional diagram of a portion of a panel with moveable separators.

FIG. 3B is a cross-sectional diagram of a portion of a panel with rotating members.

FIG. 3C is a cross-sectional diagram of a portion of a panel with extending rounded members.

FIG. 3D is a cross-sectional diagram of a portion of a panel with a moveable element.

FIG. 3E is a cross-sectional diagram of a portion of a panel with interspersed members.

FIG. 3F is a cross-sectional diagram of a portion of a panel with non-uniform members.

FIG. 3G is a cross-sectional diagram of a portion of a panel with an edge-mounted member.

FIG. 3H is a cross-sectional diagram of a portion of a panel with multidirectional rotating members.

FIG. 4 is a schematic diagram of an example system for generation of electrical power from wind energy harvester arrays.

FIG. 5 is a block diagram of a control system for a power generation system.

FIG. 6A shows wind energy harvesting panels connected in parallel.

FIG. 6B shows wind energy harvesting panels connected in series.

FIG. 7 is a flow diagram of an example process for generating electrical power.

Like reference numbers and designations in the various drawings indicate like units.

### DETAILED DESCRIPTION

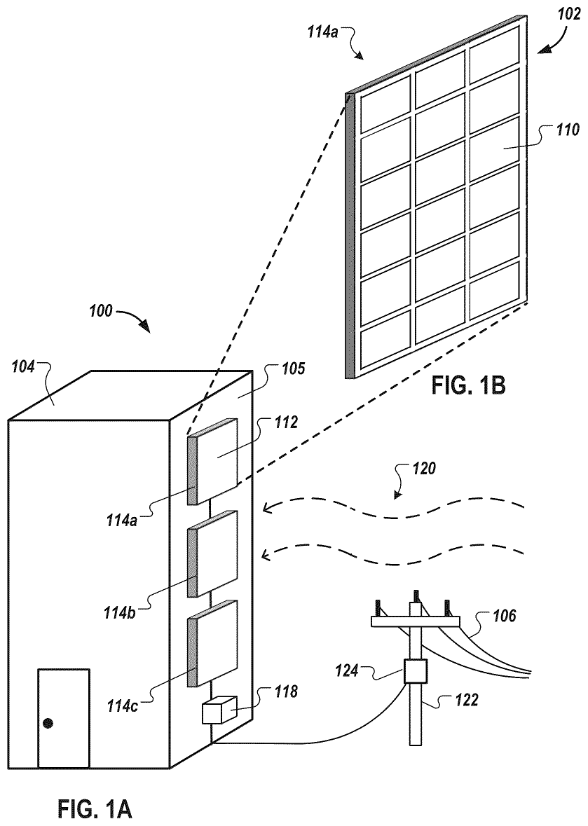

FIG. 1A is a contextual diagram of an example system for generation of electrical power from wind energy harvester arrays. The system 100 includes building 104 and utility pole 122. Wind energy harvesting panels 114a, 114b, 114c (“panels 114”) are installed on a side 105 of the building 104. Wind, including flowing air 120, is incident on the side 105 of the building 104.

Wind is a flow of air. The panels 114 convert energy from the flowing air 120 to electrical energy. The panels 114 can convert wind energy from air flow in any direction. For example, each panel has a surface, e.g., surface 112 of panel 114a, that extends in a plane. The movement of the air 120 can be in a direction that is directly incident on the surface 112, such that the direction of wind is approximately orthogonal to the plane. In some examples, the direction of movement of the air 120 can be incident on the surface 112 at an angle between zero and ninety degrees relative to the surface 112. In some examples, the direction of movement of the air 120 can be parallel, or approximately parallel, to the surface 112.

The panels 114 can be connected in series or in parallel. In some examples, the panels 114 are connected in a daisy chain configuration. In some examples, the panels 114 are connected in a hub-and-spoke configuration. Though the system 100 includes three panels, more or fewer panels are possible. Though the panels 114 of the system 100 are installed on the same side 105 of the building 104 and have a same orientation, other configurations are possible. Panels can be installed on any number of sides of the building 104, on the roof of the building 104, or both. In some examples, the panels can be freestanding.

The panels 114 can have a standardized design to enable highly-automated high-throughput manufacturing. The panels 114 can be lightweight to enable building retrofitting and minimize structural building requirements. In some examples, the panels 114 can perform a secondary function as a thermal shield for the building 104. In some examples, the panels 114 can provide protection to the building 104 from environmental elements, e.g., sun, rain, wind.

The system 100 includes a power management module 118. The power management module 118 includes a power management circuit. The power management module 118 can include a power inverter.

The system 100 includes a utility pole 122 of an electrical distribution system. The utility pole 122 supports three-phase distribution lines 106. The distribution lines 106 transport electrical power to electrical loads, which can include loads of the building 104. The utility pole 122 supports a transformer 124. The panels 114 are connected to the transformer 124 through the power management module 118. The panels provide electrical power to the electrical distribution system through the transformer. In some examples, the panels 114 can provide electrical power to loads of the building 104 in addition to, or instead of, providing electrical power to the electrical distribution system.

FIG. 1B shows a larger view of the panel 114a. The panel 114a includes an array 102 of wind energy harvesting units 110. In some examples, the panel 114a has a surface area of twenty square feet or less (e.g., ten square feet or less, five square feet or less, three square feet or less). In some examples, the panel 114a has a surface of ten square meters or less (e.g., eight square meters or less, five square meters or less, two square meters or less). The panel 114a has a planar shape. Other shapes are possible. In some examples, a panel can have a curved or bent shape.

For simplicity of illustration, the array 102 is shown as only including eighteen units 110. In some examples, the array 102 includes at least one hundred units 110. In some examples, the array 102 includes hundreds or thousands of units 110. The array 102 includes units 110 arranged in a two-dimensional rectangular planar array including rows and columns. In some examples, the array can be a circular array, a linear array, or other type of array.

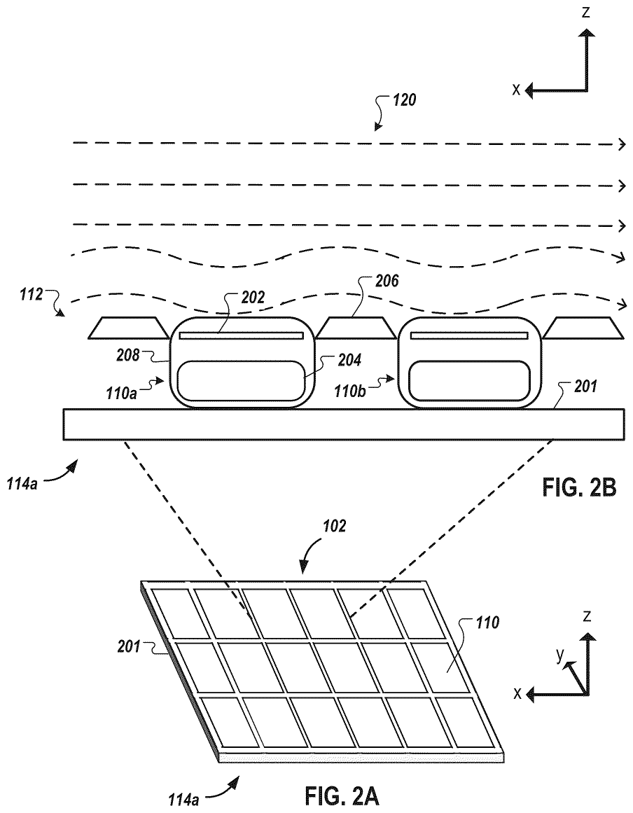

FIG. 2A shows the example panel 114a including the array 102 of wind energy harvesting units 110. FIG. 2B is a cross-sectional diagram of a section of the example panel 114a. The panel 114a includes a frame 201. The units are supported by the frame 201. The frame 201 can be made from a rigid material (e.g., aluminum, stainless steel).

The units 110 of the array 102 each include a wind energy harvester. The units are configured to convert fluid-induced mechanical energy to electrical energy. The units can be made from materials such as plastic, Teflon, Nylon, PVC. In some examples, a unit 110 has a polygonal shape in the x-y plane (e.g., quadrilateral, rectangular, square, parallelogrammatic, trapezoidal, triangular). In some examples, a unit 110 has a rounded shape in the x-y plane (e.g., circular, oval, elliptical, oblong).

A wind energy harvester is a mechanism that can obtain power from aeroelastic instabilities and unsteady flow such as vortex-induced vibration or galloping and flutter. An example of such phenomena can be a consequence of effects such as vortex shedding from a bluff body and can generate motion at a relatively low wind velocity. An example wind energy harvester is a wind-induced vibration wind energy harvester that is designed to let wind blow over a structure to cause mechanical vibration. The air flow's kinetic energy is first converted into vibration energy. The vibration energy is then converted into electrical energy by an electromechanical conversion mechanism. In this way, wind-induced vibration wind energy harvesters transform the wind into structural vibration via a hydrodynamic instability or unsteady flow. Both galloping-based and flutter-based wind energy harvesters are able to convert wind energy also due to air drag.

In some examples, the wind energy harvester is a triboelectric nanogenerator wind energy harvester. A triboelectric nanogenerator generates electricity based on the conjunction of the triboelectrification and electrostatic induction. A triboelectric nanogenerator can generate electrical energy from wind-induced vibration with high efficiency, low cost, light weight, simple structure, and using a wide range of materials.

The triboelectric effect results from the cyclic contact and separation of two different materials with different electron affinity, which is defined as the triboelectric series. The triboelectric series ranks materials according to their tendency to gain or lose electrons. The process of electron transfer as a result of two objects coming into contact with one another and then separating is called triboelectric charging. During such an interaction one of the two objects will always gain electrons (becoming negatively charged) and the other object will lose electrons (becoming positively charged). The relative position of the two objects on the triboelectric series will define which object gains electrons and which object loses electrons. The lower the material's position in the series, the better its ability to obtain electrons and get negatively charged, and the further apart two materials are in the triboelectric series, the more transfer charges are generated during the physical contact. Tribo-materials include, for example, metal, nylon, silicone rubber, and polytetrafluoroethylene (PTFE).

When two triboelectric materials with different electron affinities come into physical contact, tribo-charges are separated and transferred from one material to the other. The surface of the material with higher electron affinity becomes negatively charged, while the other surface becomes positively charged with an equal amount. When the two materials separate, the tribo-charges in the interfacial regions too are separated, inducing an electrical potential difference between electrodes, and driving free electrons to flow back and forth in the external circuit to maintain the electrostatic equilibrium. The fundamental working modes of a triboelectric nanogenerator can be divided into the following four categories: vertical contact-separation mode, lateral sliding mode, single-electrode mode, and freestanding triboelectric-layer mode.

An example triboelectric nanogenerator wind energy harvester includes a flapping film that is formed by plastic deformation of polymer film at elevated temperatures. The film forms a curved shape by plastic deformation, and creates a variable gap between the flap and a substrate. The flapping film vibrates when the wind is introduced. The energy is generated while the contact area changes according to the deformation of the flapping film. The triboelectric nanogenerator wind energy harvester can convert wind energy at various speeds and directions.

An example triboelectric nanogenerator generates electrical energy from a fluid-flexible structure interaction between two films, where either both films are moving or where one film is moving and the other one is stationary. The dynamics of this structure can be classified into four states: stable (no contact), out-of-phase flapping, in-phase flapping, and chaotic. The dynamics can be utilized to develop a triboelectric nanogenerator dominated by the Venturi effect, von Karman vortex, and/or Helmholtz resonance. The triboelectric nanogenerator can include including a first element that is a ferroelectric polyvinylidene fluoride (PVDF) film coated with fluorinated polyethylene propylene (FEP), and a second element that is a PVDF film connected to an electrode. In some examples, a triboelectric nanogenerator includes an element that is polytetrafluoroethylene (PTFE) with an intercalated aluminum layer connected to an electrode. In some examples, a triboelectric nanogenerator includes a cross-shaped dielectric film bent in four directions. The triboelectric nanogenerator can produce a consistent electrical power output from wind in any direction.

The panel 114a includes unit 110a and unit 110b (“units 110”). The unit 110a and the unit 110b are supported by the frame 201. The units 110a and the unit 110b are separated from each other by a separator 206 that is between adjacent units 110a and 110b.

In some examples, each unit 110 of the array 102 is separated from adjacent units by a separator 206. The separator 206 is positioned in between adjacent units of the array 102. The separator 206 can be made from a rigid material such as metal or plastic. In some examples, the separator 206 has a flat surface that is exposed to the environment. In some examples, the separator 206 has a width, e.g., in the x-direction, that is less than the width of the unit 110a in the x-direction. For example, the separator 206 can have a width in the x-direction of one centimeter (cm) or less (e.g., 0.7 cm or less, 0.5 cm or less, 0.3 cm or less). The unit 110a can have a width in the x-direction of two centimeters or less (e.g., 1.5 cm or less, 1.0 cm or less, 0.8 cm or less). In some examples, the width of the separator 206 is one-half or less the width of the unit 110a. For example, the unit 110a can have a width of approximately 1.0 cm, and the separator 206 can have a width of approximately 0.5 cm.

In some examples, the separator 206 is fixed relative to the frame 201. In some examples, the separator 206 is moveable relative to the frame 201. In some examples, the separators 206 provide support for the units 110. In some examples, the separators 206 are part of the frame 201. A separator 206 can be, for example, a rail extending across the panel 114 and separating two adjacent rows or columns of units 110. During operation, the separators 206 are exposed to the air flow of the wind.

Each unit has a surface area in the x-y plane. In some examples, each unit has a surface area of ten square centimeters or less (e.g., five square centimeters or less, three square centimeters or less, one square centimeter or less).

The unit 110a includes a wind energy harvester including a first element 202 and a second element 204. In some examples, the first element 202 is formed from a different material than the second element 204. In some examples, the first element 202 is formed from a material having a first position in the triboelectric series, and the second element 204 is formed from a material having a second position in the triboelectric series that is different from the first position.

In some examples, the first element 202, the second element 204, or both, include a plastic film. In some examples, the first element 202 is planar. In some examples, the second element 204 is planar and parallel to the first element 202. In some examples, the first element 202 and the second element 204 are enclosed in a housing 208. The housing 208 can be permeable, semi-permeable, or impermeable to air. The housing 208 can be impermeable or semi-impermeable to water.

In some examples, the first element 202 has a first position in the unit 110a and the second element 204 has a second position in the unit 110a that is different from the first position. The second element 204 is spaced apart from the first element 202 when the unit 110a is in the resting state. The first element 202 and the second element 204 can be configured to remain spaced apart when the unit 110a is in a resting state. The first element 202 and the second element 204 are configured to come into contact with each other when a force is applied to the unit 110a, e.g., a force exerted by the air 120. In some examples, the force exerted by the air 120 is dependent on a parallel component of air flow across the surface of the panel 114a. In the example of FIGS. 2A and 2B, the parallel component of air flow is the component of air flow in the x-y plane.

In some examples, the first element 202 is moveable relative to the housing 208 and the second element 204 is rigid relative to the housing 208. In some examples, both the first element 202 and the second element 204 are moveable relative to the housing 208. Relative motion between the first element 202 and the second element 204 generates electrical energy. In some examples, the first element 202, the second element 204, or both are connected to electrodes. Electrodes can capture electrons transferred between the first element 202 and the second element 204. Wires connected to the electrodes can transfer electric current to and from the wind energy harvester of the unit 110a.

During operation, air 120 flows past the panel 114a. The surface 112 of the panel 114a is not smooth, e.g., due to the units 110 being interspersed with the separators 206. Thus, air 120 flowing near the surface 112 of the panel 114a experiences unsteady flow or turbulence. Air flowing past the unit 110a causes pressure fluctuations and thus oscillations of the first element 202. Due to force exerted by the air 120, the first element 202 moves relative to the second element 204. For example, the first element 202 can vibrate, flap, or flutter, relative to the second element 204. In some examples, the first element 202 vibrates in the z-direction, e.g., the direction perpendicular to the surface 112 of the panel 114a.

The unit 110a generates electricity through a combination of triboelectric effect and electrostatic induction resulting in a charge transfer between the first element and the second element. The unit 110a can generate electricity from energy caused by small-scale physical changes, e.g., relative motion, on the order of millimeters. The relative motion creates a charge that is then transferred to electrodes. In this way, electrical power can be generated from oscillations of the first element 202 relative to the second element 204.

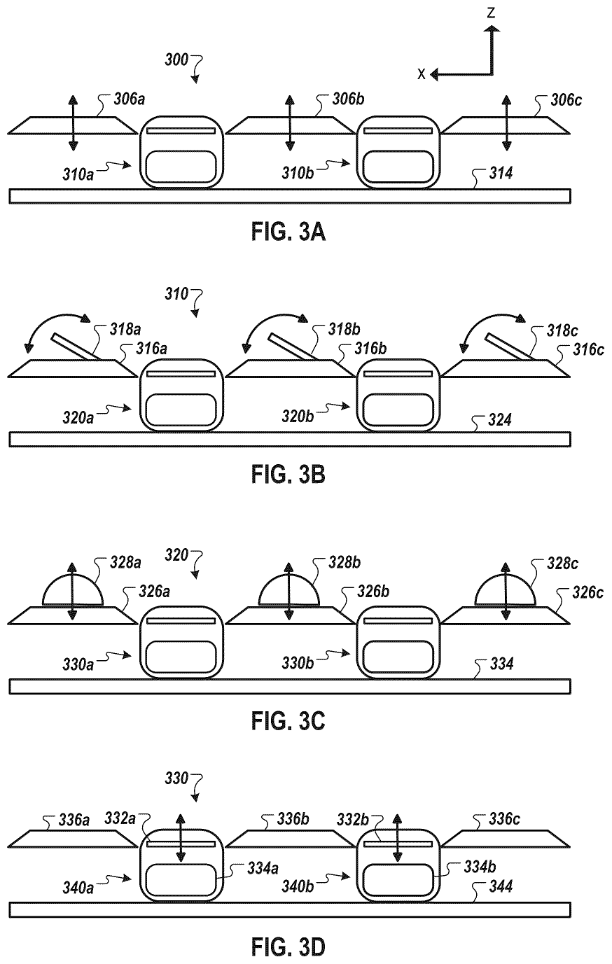

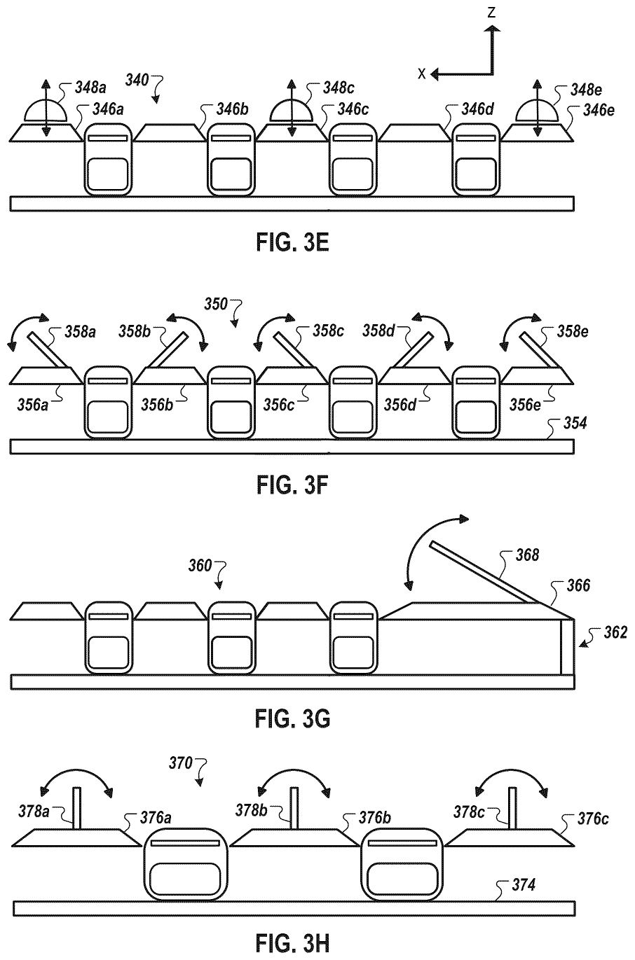

FIGS. 3A to 3H are cross-sectional diagrams of portions of example panels with moveable members. The example panels each include at least one member that is moveable by an actuator. An actuator is a device that is responsible for moving or controlling a mechanism such as the members of the example panels. The actuator is controlled by a signal from a control system. The actuator can be operated by a source of energy such as a mechanical force, electrical current, hydraulic fluid pressure, or pneumatic pressure. The actuator converts the energy into motion.

The member is moveable relative to the frame. The member can be, for example, a wing, a half sphere, a tower, a cylinder, a plate, a louver, or other form of moveable member. In some examples, the member extends from a surface of the panel. In some examples, the moveable member is integrated with the surface of the panel. The member can be located between adjacent units of the array, and can be mounted to a separator between the adjacent units. In some examples, the member is mounted to the frame.

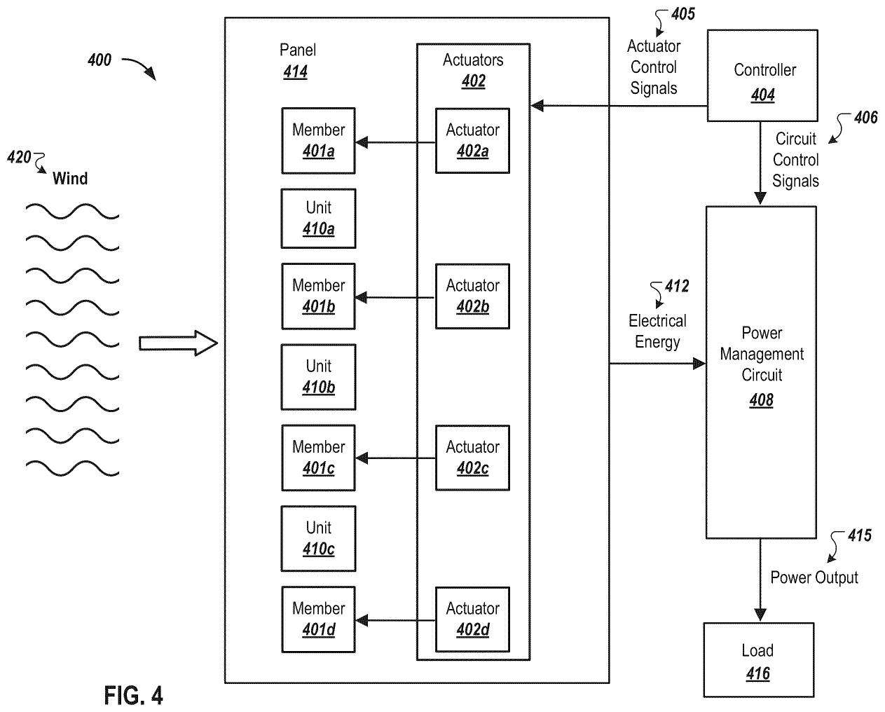

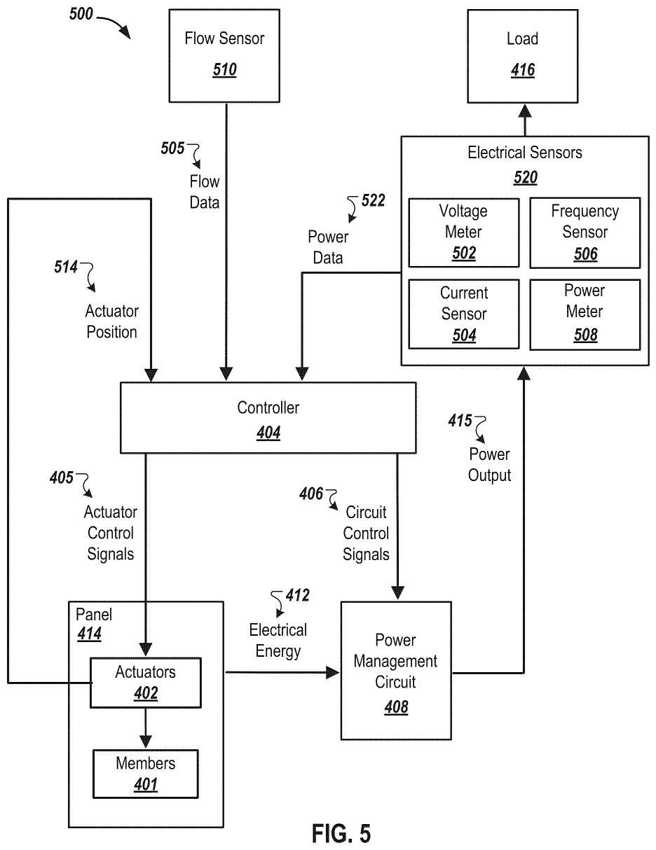

In some examples, the system includes a plurality of members that are each moveable relative to the frame. The plurality of members can be uniform or can be different from each other. For example, the plurality of members can include wings that are all of the same shape and size, wings that are of different shapes and sizes, or a combination of wings and of members having another shape, such as half spheres. In some examples, movement of each member is controlled individually. In some examples, movement of the members is controlled uniformly. Control of the movement of the members is described in greater detail with reference to FIGS. 4 and 5.

In some examples, the actuator moves the member from a first position to a second position. Moving the member from the first position to the second position can redirect or divert the flow of air over the units. In some examples, changing the position of the member increases or decreases the speed of air flow over the units. In some examples, changing the position of the member changes the direction of air flow over the units. In some examples, the members can form channels or funnels that guide air flow over the units.

FIG. 3A is a cross-sectional diagram of a panel 300 with moveable separators. In the example of panel 300, the moveable members are the separators 306a, 306b, 306c (“separators 306”) adjacent to the units 310a, 310b. The separators 306 are moveable up and down in the z-direction relative to the frame 314.

The separators 306 can move along the z-axis to change the height position of the separators. The height of the separators 306 can be measured with reference to the frame 314. When the separators 306 are at a higher position, there is a greater distance between the separators 306 and the frame. When the separators 306 are at a lower position, there is a smaller distance between the separators 306 and the frame 314. In some examples, the separators 306 can raise and lower together, such that the height of the separators 306 is uniform across the panel. In some examples, the separators 306 can raise and lower independently, such that the height of separator 306a may be different from the height of separator 306b.

Changing the position of the separators 306 can affect the force of air flow on the units 310a, 310b. For example, when the separators 306 have a lower position, the units 310a, 310b may be more exposed to air flow and may be subject to a greater force from the air flow. When the separators 306 have a higher position, the units 310a, 310b may be less exposed to air flow and may experience increased unsteady flow conditions and oscillating pressure.

FIG. 3B is a cross-sectional diagram of a portion of a panel 310 with rotating members 318a, 318b, 318c (“members 318”). The members 318a, 318b, 318c are mounted to the separators 316a, 316b, 316c, respectively. The members 318 can be, for example, wings or louvers that are each mechanically coupled at one or more edges to a separator 316. A surface of the frame 324 and a surface of the separators 316 both extend in the x-y plane.

The members 318 are rotatable in the x-z plane. The members 318 can be rotated to change the angle of the members 318. An angle of the members 318 can be measured with reference to the x-y plane (e.g., with reference to the surface of the frame 324, with reference to the surface of the separators 316, or both). The angle of the members 318 can be adjustable between a minimum angle (e.g., zero degrees) and a maximum angle (e.g., 90 degrees or 180 degrees). In some examples, the members 318 can rotate together, such that the angle of the members 318 is uniform across the panel. In some examples, the members 318 can rotate independently, such that the angle of member 318a may be different from the angle of member 318b.

Changing the angle of the members 318 can affect the force of air flow on the units 320a, 320b. For example, when the members 318 have a smaller angle, the units 320a, 320b may be more exposed to air flow and may be subject to a greater force from the air flow. When the separators 306 have a greater angle, the units 310a, 310b may be less directly exposed to air flow and may experience increased unsteady flow conditions and oscillating pressure.

FIG. 3C is a cross-sectional diagram of a portion of a panel 320 with extending members 328a, 328b, 328c (“members 328”). The members 328a, 328b, 328c are mounted to the separators 326a, 326b, 326c, respectively. The members 328 can be, for example, cylindrical, spherical, or rectangular protrusions.

The members 328 are extendable or expandable in the z-direction. The members 328 can extend or expand away from the separators 326 and can contract or retract towards the separators 326 in the z-direction to change the height of the members. The height of the members 328 can be measured with reference to the surface of the separators 326 to which the members 328 are attached.

In some examples, the members 328 can extend and retract together, such that the height of the members 328 is uniform across the panel. In some examples, the members 328 can extend and retract independently, such that the height of member 328a may be different from the height of member 328b.

Changing the position of the members 328 can affect the force of air flow on the units 330a, 330b. For example, when the members 328 have a lesser height, the units 330a, 330b may be more exposed to air flow and may be subject to a greater force from the air flow. When the members 328 have a greater height, the units 310a, 310b may be less directly exposed to air flow and increased unsteady flow conditions and oscillating pressure.

FIG. 3D is a cross-sectional diagram of a portion of a panel 330 with moveable members. In the example of panel 330, the moveable members are the first elements 332a, 332b (“first elements 332”) of the units 340a, 340b. The first elements 332 are moveable up and down in the z-direction relative to the frame 344. In some examples, in addition to or instead of the first elements 332, second elements 334a, 334b of the units 340a, 340b can be moveable.

The first elements 332 can move along the z-axis to change the distance between the first elements 332 and the respective second elements 334. For example, the first element 332a can move up and down along the z-axis to change the distance between the first element 332a and the second element 334a of the unit 340a. In some examples, the first elements 332 can raise and lower together, such that the distance between the first elements 332 and second elements 334 is uniform across the panel. In some examples, the first elements 332 can raise and lower independently, such that the distance between the first element 332a and the second element 334a may be different from the distance between the first element 332b and the second element 334b.

FIG. 3E is a cross-sectional diagram of a portion of a panel 340 with interspersed members 348a, 348c, 348e (“members 348”). The members 348 can be, for example, cylindrical, spherical, or rectangular protrusions. The members 348 are extendable or expandable in the z-direction.

The members 348 are interspersed across the panel 340. For example, the members 348a, 348c, 348e are mounted to the separators 346a, 346c, 346e, respectively. No members are mounted to the separators 346b or 346d. In some examples, members are mounted to every other separator across the panel in the x-direction, in the y-direction, or both.

FIG. 3F is a cross-sectional diagram of a portion of a panel 350 with non-uniform moveable members 358a, 358b, 358c, 358d, 358e (“members 358”). The members 358a, 358b, 358c, 358d, 358e are mounted to the separators 356a, 356b, 356c, 356d, 356e, respectively. The members 358 can be, for example, wings or louvers that are each mechanically coupled at one or more edges to a separator 356.

The members 358 are rotatable in the x-z plane. The members 358 can be rotated to change the angle of the members 318 relative to the surface of the frame 354. The angles of the members 358a, 358c, 358e increase when the members 358a, 358c, 358e rotate in a clockwise direction in the x-z plane. The angles of the members 358b, 358d increase when the members 358b, 358d rotate in a counterclockwise direction in the z-direction.

In some examples, the members 358 can rotate together, such that the angle of the members 358 is uniform across the panel. In some examples, the members 358 can rotate independently, such that the angle of member 358a may be different from the angle of member 358b. In some examples, the members 358a, 358c, 358e are part of a first subset of members and the members 358b, 358d are part of a second subset of members. The members of the first subset can rotate together, such that the angles of the members 358a, 358c, 358e are the same. The members of the second subset can rotate together, such that the angles of the members 358b, 358d are the same.

FIG. 3G is a cross-sectional diagram of a portion of a panel 360 with an edge-mounted moveable member 368. The member 368 is mounted to a separator 366 positioned at an edge 362 of the panel 360. The member 368 is a wing or louver that is rotatable in the x-z plane. In some examples, the panel 360 includes multiple members 368. For example, the panel 360 can include a member mounted to two or more edges of the panel 360. In some examples, the panel 360 includes a member mounted to each edge of the panel 360.

FIG. 3H is a cross-sectional diagram of a portion of a panel 370 with multidirectional rotating members 378a, 378b, 378c (“members 378”). The members 378a, 378b, 378c are mounted to the separators 376a, 376b, 376c, respectively. The members 378 can be wings or louvers that are each mechanically coupled at one or more edges to a separator 366.

The members 378 are rotatable in the x-z plane. The members 378 can be rotated to change the angle of the members 378. An angle of the members 378 can be measured with reference to the x-y plane (e.g., with reference to the surface of the frame 374, with reference to the surface of the separators 376, or both). The angle of the members 378 can be adjustable in the clockwise and counterclockwise direction in the x-z plane. In some examples, the members 318 can rotate together, such that the angle of the members 378 is uniform across the panel. In some examples, the members 378 can rotate independently, such that the angle of member 388a may be different from the angle of member 378b.

FIG. 4 is a schematic diagram of an example system 400 for generation of electrical power from wind energy harvester arrays. The system 400 includes a panel 414, a controller 404, a power management circuit 408, and a load 416.

The panel 414 includes an array of units including units 410a, 410b, 410c, 410d (“units 410”). The panel 414 includes members 401a, 401b, 401c, 401d (“members 401”). The members 401 are moveable by actuators 402a, 402b, 402c, 402d (“actuators 402”). The actuators 402 move the members 401 in response to receiving control signals from the controller 404. In some examples, each member 401 is moveable by a respective actuator 402. For example, the member 401a can be moveable by the actuator 402a and the member 401b can be moveable by the actuator 402b. In some examples, two or more members 401 can be moveable by the same actuator 402.

During operation, wind 420 is incident on the units 410 of the panel 414. The units 410 convert the mechanical energy of the wind 420 to electrical energy 412. Electrical energy 412 generated by the units 410 can be generated in power bursts that are non-monotonic due to varying aerodynamic, mechanical, and electromagnetic properties. For example, wind conditions can be inconsistent and unsteady. Therefore, the wind 420 may cause sporadic and variable mechanical oscillations in the units 410.

The generated power can be produced in short bursts of high voltage on the order of hundreds of volts, and of low current on the order of microamps. Thus, the electrical energy 412 output by the panel 414 is processed by a power management circuit 408. The power management circuit 408 is configured to receive electrical energy from the units 410 of the system 400 and to output electrical current. The power management circuit 408 converts the energy to a usable voltage-amperage range and smooths the power output. The power management circuit 408 performs power conversion and clean up of the electrical energy 412. Though shown as a separate component from the panel 414, in some examples the power management circuit 408 is integrated with the panel 414.

The power management circuit 408 combines alternating current waveforms from the units 410 into a smoothed output. The power management circuit 408 can include, for example, rectifiers, filtering capacitors, and pulse delay circuits. The power management circuit 408 provides a usable electrical power output 415 to a load 416. In some examples, the power management circuit 408 converts electrical energy 412 having a higher voltage and a lower current to a power output 415 having a lower voltage and a higher current.

The controller 404 provides actuator control signals 406 to the panel 414, or both. In some examples, the panel 414 and/or components of the panel 414 are moveable. For example, the panel can include moveable members. The members 401 are moveable by the actuators 402. The actuators 402 are communicably coupled to the controller 404. The controller 404 can control movement of the members 401 using the actuator control signals 406. For example, the actuator control signals 406 can cause the actuators 402 to raise, lower, expand, contract, extend, retract, or rotate the members 401.

The controller 404 provides circuit control signals 406 to the power management circuit 408. The controller 404 can control parameters of the power management circuit 408 using the circuit control signals 406. In some examples, the controller 404 is a proportional-integral derivative (PID) controller. A PID controller is a control loop mechanism employing feedback that is used for continuously modulated control. A PID controller calculates an error value as the difference between a setpoint and a measured process variable and applies a correction based on proportional, integral, and derivative terms. In some examples, the controller can be a computational unit running a machine learning model locally or remotely via data centers.

FIG. 5 is a block diagram of a control system 500 for a power generation system. The control system 500 includes the controller 404, the panel 414, the actuators 402, the power management circuit 408, and the load 416. The control system 500 includes electrical sensors 520 including a voltage meter 502, a current sensor 504, a frequency sensor 506, and a power meter 508. The electrical sensors 520 measure parameters of the power output 415 provided by the power management circuit 408 to the load 416. The control system 500 includes a flow sensor 510. The flow sensor measures characteristics of air flow over the panel.

The voltage meter 502 measures the voltage of the power output 415 provided to the load 416 by the power management circuit 408. The voltage meter 502 outputs the measured voltage (e.g., in volts) as power data 522 to the controller 404. In some examples, in addition to or instead of the voltage meter 502, the control system 500 includes a voltage sensor that measures the voltage of electrical energy 412 output by the panel 414 and outputs the measured voltage as power data 522 to the controller 404.

The current sensor 504 measures the current of the power output 415 provided to the load 416 by the power management circuit 408. The current sensor 504 outputs the measured current (e.g., in amperes) as power data 522 to the controller 404. In some examples, in addition to or instead of the current sensor 504, the control system 500 includes a current sensor that measures the current of electrical energy 412 output by the panel 414 and outputs the measured current as power data 522 to the controller 404.

The frequency sensor 506 measures the frequency of the power output 415 provided to the load 416 by the power management circuit 408. The frequency sensor 506 outputs the measured frequency (e.g., in Hertz) as power data 522 to the controller 404. In some examples, in addition to or instead of the frequency sensor 506, the control system 500 includes a frequency sensor that measures the frequency of electrical energy 412 output by the panel 414 and outputs the measured frequency as power data 522 to the controller 404.

The power meter 508 measures the power of the power output 415 provided to the load 416 by the power management circuit 408. The power meter 508 outputs the measured power (e.g., in Watts) as power data 522 to the controller 404. In some examples, in addition to or instead of the power meter 508, the control system 500 includes a power meter that measures the power of electrical energy 412 output by the panel 414 and outputs the measured power as power data 522 to the controller 404.

Although shown as including the voltage meter 502, the current sensor 504, the frequency sensor 506, and the power meter 508 the control system 500 can include more or fewer electrical sensors 520. For example, in some implementations, the control system 500 includes the voltage meter 502 and the current sensor 504, but does not include the frequency sensor 506 or the power meter 508.

The flow sensor 510 measures flow characteristics and provides the flow characteristics as flow data 505 to the controller 404. The flow characteristics can include, for example, flow speed, flow direction, flow pressure, or any combination of these. The flow sensor 510 can be positioned on or near the panel 414 and can measure air flow past the panel 414. In some examples, the flow sensor 510 is an anemometer.

In some examples, the control system 500 includes one flow sensor 510 that measures bulk air flow over the panel 414. In some examples, the control system 500 includes multiple flow sensors. For example, a flow sensor can be mounted to each edge or corner of the panel 414.

The controller receives flow data 505 indicating the flow characteristics of air flow over the panel 414. In some examples, the controller 404 aggregates or averages flow characteristics measured by multiple flow sensors.

In some examples, the controller 404 determines flow speed and/or direction of a parallel component of air flow. For example, wind may be incident on the panel 414 at an angle relative to the surface of the panel 414. The flow sensor 510 can output, to the controller 404, flow data 505 indicating the flow characteristics such as speed and direction of air flow incident on the panel 414. Using the flow characteristics, the controller 404 can determine the speed and/or direction of the component of air flow that is parallel to the surface of the panel 414.

The controller 404 receives the power data 522 from the electrical sensors 520 indicating electrical parameters of the power output 415. The electrical parameters can include the measured voltage, current, frequency, power, or any of these.

The controller 404 receives data indicating an actuator position 514. In some examples, the actuator position 514 is the same for all actuators 402 of the panel. In some examples, the actuator position 514 is the same for a subset of actuator 402. In some examples, the actuator position 514 is different for individual actuators 402.

The controller 404 can store target electrical parameters for power output. The target parameters can include, for example, a target voltage, target current, current frequency, target power, or any of these. In some examples, the target parameters include a range of parameters, e.g., a target voltage range, a target current range, a target frequency range, a target power range.

For a particular nanogenerator configuration, there may be a point of optimal power output subject to generator dimensions and air flow. The target parameters can be calibrated for the nanogenerator configuration of the panel based on achieving a maximum extractable wind power for various flow characteristics.

In some examples, the target parameters are independent of flow characteristics. For example, the controller 404 can store a data table of target electrical parameters that are applicable at any air flow speed. The controller 404 can compare parameters of the power output 415, as indicated by the power data 522, to the target parameters. For example, the controller 404 can compare the voltage measured by the voltage meter 502 to a stored target voltage.

In some examples, the target parameters are associated with flow characteristics. For example, the controller 404 can store a data table that associates one or more target parameters with ranges of air flow speeds. The controller 404 can compare parameters of the power output 415, as indicated by the power data 522, to the target parameters for the associated flow characteristics. For example, the controller 404 can select a target voltage for the air flow speed indicated by the flow data 505. The controller 404 can compare the voltage measured by the voltage meter 502 to the selected target voltage.

The controller 404 generates the actuator control signals 405 based on the flow data 505, the power data 522, the actuator position 514, or any combination of these. In some examples, the controller 404 determines that an electrical parameter indicated by the power data 522 matches a target parameter within a threshold error. In response to determining that the electrical parameter indicated by the power data 522 matches the target parameter within the threshold error, the controller 404 can determine not to send any actuator control signals 405, or can determine to send actuator control signals 405 that cause the actuators 402 to maintain the members in their current positions.

In some examples, the controller 404 determines that the electrical parameter indicated by the power data 522 does not match the target parameter within the threshold error. In response to determining that the electrical parameter indicated by the power data 522 does not match the target parameter within the threshold error, the controller 404 can determine to send actuator control signals 405 to cause the actuators 402 to move members 401 of the panel 414.

In some examples, the control system 500 does not include the flow sensor 510, and the controller 404 can generate the actuator control signals 405 based on comparing the electrical parameters to target parameters, independent of flow characteristics.

In some examples, the control system 500 does not include the electrical sensors 520, and the controller 404 generates the actuator control signals 405 based on comparing the flow data 505 to target flow characteristics, independent of power data 522.

In some examples, the controller 404 can use machine learning processes to determine target actuator positions. For example, a machine learning model can be trained to determine optimal actuator positions for various flow characteristics and/or power parameters.

In some examples, the machine learning model can be generically trained prior to installation of the panel 114. After the panel 114 is installed, the machine learning model can train over time to determine optimal actuator positions for the actuators 402 of the panel 414 at the installation location under various flow conditions.

In some examples, the machine learning model can receive, as input, the flow data 505 and the power data 522, and can output a target actuator position. The controller 404 can compare the target actuator position to the current actuator position 514. Based on the comparison between the target actuator position and the current actuator position 514, the controller 404 can generate actuator control signals 405 to move the actuators 402 from the current actuator position 514 to the target actuator position.

The controller 404 outputs the actuator control signals 405 to the actuators 402. The actuator control signals 405 can cause the actuators 402 to move the members 401 of the panel 414. In some examples, movement of each member is controlled individually. In some examples, movement of the members is controlled uniformly. In some examples, a first subset of members is controlled separately from a second subset of members.

In some examples, the actuator control signals 405 instruct the actuators 402 to move to a particular position. For example, the actuator control signals 405 can instruct the actuators 402 to rotate to a particular angle. When the actuators 402 receive the actuator control signals 405, the actuators 402 rotate to the particular angle and stop.

In some examples, the actuator control signals 405 instruct the actuators to move in a particular direction. For example, the actuators control signals 405 can instruct the actuators to rotate in a clockwise direction. When the controller 404 determines that the current actuator position 514 matches a target actuator position 514 within a threshold error, the controller 404 can stop transmitting the actuator control signals 405, such that the actuators 402 remain stationary in the current actuator position.

The actuators 402 move the members 401 in response to receiving the actuator control signals 405 from the controller 404. The actuators 402 adjust the position of the members 401 relative to the frame. An actuator 402 can increase or decrease an angle between a member 401 and the frame, raise or lower the member 401 relative to the frame, extend or retract the member 401 relative to the frame, or any of these. Movement of the members 401 relative to the frame was described in greater detail with reference to FIGS. 3A to 3H.

Movement of the members 401 relative to the frame changes the aerodynamic profile of the panel 414, and can change the flow characteristics of air flow over the panel 414. For example, changing the positions of the members 401 can affect the speed and/or direction of fluid flow over the units 410 of the panel 414.

After the actuators 402 move the members 401, the electrical sensors 520 measure the power output 415 from the power management circuit 408 and output power data 522 to the controller 404. The controller 404 also receives, as input, updated flow data 505 and actuator position 514. The controller 404 uses the power data 522, the flow data 505, and/or the actuator position 514 to determine whether or not to continue to adjust the positions of the members 401.

In some examples, the controller 404 can iteratively adjust the members 401 until the target parameters are achieved within specified error margins. For example, the controller 404 can continue to adjust the members 401 until a measured flow speed matches a target flow speed, until a measured air pressure matches a target air pressure, until an electrical parameter of the power output 415 matches a target electrical parameter, or until the actuator position 514 matches a target actuator position, or any of these.

In some examples, once target parameters are achieved, the controller 404 can maintain the actuators in their current position until a change in flow characteristics is detected. For example, the flow data 505 may indicate a steady flow speed for a duration of time. The flow data 505 may then indicate a change in flow speed that is greater than a specified tolerance. When the controller 404 receives the flow data 505 indicating the change in flow speed, the controller 404 can determine to change the member position to a new position and can generate actuator control signals 405 to cause the actuators 402 to move the members 401 to the new position.

In some examples, the power data 522 may indicate a steady voltage of the power output 415 for a duration of time. The power data 522 may then indicate a change in voltage that is greater than a specified tolerance. When the controller 404 receives the power data 522 indicating the change in voltage, the controller 404 can determine to change the member position to a new position and can generate actuator control signals 405 to cause the actuators 402 to move the members 401 to the new position.

In some examples, the controller 404 continuously computes a target actuator position and outputs actuator control signals 405 to position the actuators 402 to the target actuator position.

In an example scenario, the flow data 505 indicates an air flow speed of 5.0 meters per second (m/s) over the panel 414. The controller 404 stores data indicating that local optimum power output 415 occurs at flow speeds of 3.0 m/s and at 7.0 m/s. The controller 404 selects a target flow speed of 3.0 m/s, with a threshold error of 0.5 m/s.

The controller 404 outputs actuator control signals 405 to the actuators 402 to cause the actuators 402 to move the member 401 in order to reduce the speed of air flow over the panel 414. For example, the actuator control signals 405 can cause the members 401 to extend out of the surface of the panel, reducing the speed of air flow over the panel 414. The actuators 402 continue to move the members 401 until the flow speed indicated by the flow data 505 matches the target flow speed of 3.0 m/s plus or minus 0.5 m/s.

Alternatively, in the above scenario, the controller 404 can determine a target actuator position to achieve the target flow speed. For example, the controller 404 can determine a target actuator position using the current actuator position 514 and the current flow speed. The controller 404 may determine that a target actuator position is thirty degrees in order to achieve the target speed of 3.0 m/s. The actuator control signals 405 can therefore cause the actuators 402 to change the actuator position 514 to the target actuator position of thirty degrees.

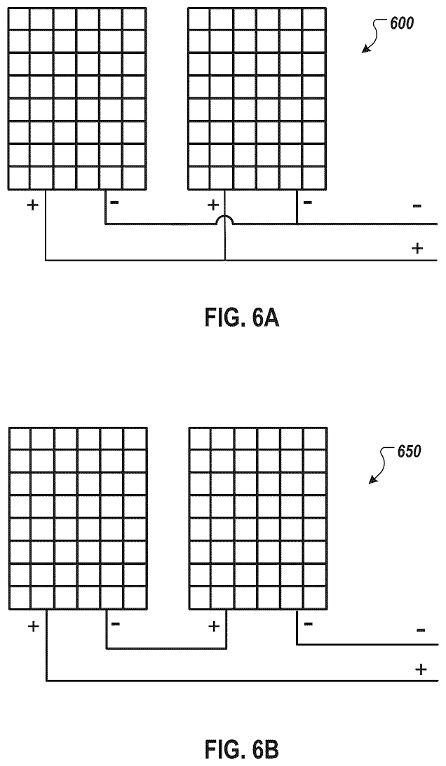

FIG. 6A shows a system 600 including wind energy harvesting panels connected in parallel. FIG. 6B shows a system 650 including wind energy harvesting panels connected in series. The systems 600, 650 each include two panels. Power generation systems can include additional panels connected in series or in parallel. In some examples, power generation systems can include hundreds or thousands of electrically connected panels. In some examples, panels can be connected using a daisy chain arrangement or hub-and-spoke arrangement.

In some examples, each panel of a system is controlled by a separate controller (e.g., controller 404). In some examples, a system of two or more panels can be controlled by a common controller. In some examples, air flow over each panel of a system is measured by a separate flow sensor (e.g., flow sensor 510). In some examples, air flow over a system of two or more panels is measured by a common flow sensor.

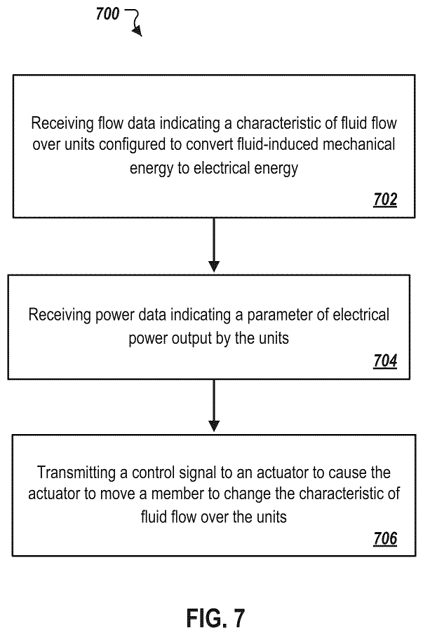

FIG. 7 is a flow diagram of an example process 700 for generating electrical power. The process 700 can be performed by one or more computing devices. For example, the process 700 can be performed by the controller 404. Operations of process 700 are described as being performed by a controller. However, some or all of the operations may be performed by various operation modules of a power generation system.

The process 700 includes receiving flow data indicating a characteristic of fluid flow over units configured to convert fluid-induced mechanical energy to electrical energy (702). For example, the controller 404 can receive flow data 505 indicating a speed, pressure, or direction of fluid flow over wind energy harvester units 410. The units 410 are supported by a frame, such as frame 201. The units 410 can be arranged in an array and can be integrated into a panel, such as panel 114a.

The process 700 includes receiving power data indicating a parameter of the electrical power output by the units (704). For example, the controller 404 can receive power data 522 indicating a voltage, frequency, current, or power of power output 415. The power output 415 is electrical power generated by the units 410 and converted by the power management circuit 408.

The process 700 includes transmitting a control signal to an actuator to cause the actuator to move a member to change the characteristic of fluid flow over the units (706). For example, the controller 404 can transmit an actuator control signal 405 to an actuator 402 to cause the actuator 402 to move a member 401 relative to the frame. Moving the member 401 changes the position of the member 401 relative to the frame. Moving the member 401 changes the characteristic of the fluid flow over the units 410. For example, moving the member 401 can increase or decrease fluid speed, can increase or decrease fluid pressure, and/or can change the direction of fluid flow over the units 410.

Embodiments of the subject matter and the operations described in this specification can be implemented, in part, by digital electronic circuitry, or in computer software, firmware, or hardware, including the structures disclosed in this specification and their structural equivalents, or in combinations of one or more of them, in additional to the structures described above.

A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal.

The operations described in this specification can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or multiple ones, or combinations, of the foregoing. While this specification contains many specific implementation details, these should not be construed as limitations on the scope of any features or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A power generation system comprising:
a frame;
a plurality of units supported by the frame and configured to convert fluid-induced mechanical energy to electrical energy;
a member that is moveable relative to the frame;
an actuator operable to move the member; and
a controller communicably coupled to the actuator and configured to perform operations comprising:
receiving, by the controller, flow data indicating a characteristic of fluid flow over the plurality of units;
receiving, by the controller, power data indicating a parameter of electrical power output by the plurality of units; and
based on the flow data and the power data, transmitting, by the controller, a control signal to the actuator to cause the actuator to move the member relative to the frame.

2. The system of claim 1, wherein the power data indicates a measured voltage of electrical energy output by the plurality of units, the operations comprising:
determining, by the controller, a target voltage; and
iteratively transmitting, by the controller, control signals to the actuator to cause the actuator to move the member relative to the frame until the measured voltage matches the target voltage within a threshold error.

3. The system of claim 1, wherein the power data indicates a measured current of electrical energy output by the plurality of units, the operations comprising:
determining, by the controller, a target current; and
iteratively transmitting, by the controller, control signals to the actuator to cause the actuator to move the member relative to the frame until the measured current matches the target current within a threshold error.

4. The system of claim 1, wherein the characteristic of fluid flow is a speed of fluid flow, the operations comprising:
determining, by the controller, a target speed of fluid flow over the plurality of units; and
iteratively transmitting, by the controller, control signals to the actuator to cause the actuator to move the member relative to the frame until the speed of fluid flow indicated by the flow data matches the target speed of fluid flow within a threshold error.

5. The system of claim 1, wherein moving the member comprises extending or retracting the member relative to the frame.

6. The system of claim 1, wherein moving the member comprises increasing or decreasing an angle formed between the member and the frame.

7. The system of claim 1, wherein the plurality of units are arranged in a planar array.

8. The system of claim 7, comprising a separator between adjacent units of the plurality of units in the planar array, wherein the member is mounted to the separator.

9. The system of claim 7, wherein the member comprises a separator that is located between adjacent units of the plurality of units in the planar array.

10. The system of claim 7, wherein the member is one of a plurality of members, each member of the plurality of members being located between adjacent units of the plurality of units in the planar array.

11. The system of claim 1, wherein the fluid flow comprises air flow.

12. The system of claim 1, wherein a first unit of the plurality of units comprises:
a first element; and
a second element, wherein relative motion between the first element and the second element generates electrical energy.

13. The system of claim 12, wherein the member comprises the first element or the second element.

14. The system of claim 12, wherein the first element is planar and wherein the second element is planar and parallel to the first element.

15. The system of claim 12, wherein the first element and the second element are configured to remain spaced apart when the first unit is in a resting state and to come into contact with each other when a force is applied to the first unit.

16. The system of claim 12, wherein:
the first element and the second element are enclosed in a housing that is permeable to air;
the first element is moveable relative to the housing; and
the second element is rigid relative to the housing.

17. The system of claim 1, wherein:
each unit has a surface area of ten square centimeters or less; and
the plurality of units comprises at least one hundred units.

18. The system of claim 1, wherein each unit of the plurality of units comprises a triboelectric nanogenerator.

19. The system of claim 1, wherein movement of the member relative to the frame changes the characteristic of fluid flow over the units.

20. A computer-implemented method comprising:
receiving, by a controller, flow data indicating a characteristic of fluid flow over a plurality of units configured to convert fluid-induced mechanical energy to electrical energy, the plurality of units being supported by a frame;
receiving, by the controller, power data indicating a parameter of electrical power output by the plurality of units; and
based on the flow data and the power data, transmitting, by the controller and to an actuator that is operable to move a member relative to the frame, a control signal to cause the actuator to move the member.
